(19) United States
(12) Patent Application Publication
(10) Pub. No.: US 2014/0295859 A1
(43) Pub. Date: Oct. 2, 2014

(54) METHOD OF SELECTING A PLURALITY OF CELLS AND METHOD OF DISTRIBUTED-TRANSMITTING DATA FOR ENHANCING TRANSMISSION RATE OF MOBILE DATA IN WIRELESS OVERPLAY NETWORK

(71) Applicant: Electronics and Telecommunications Research Institute, Daejeon (KR)

(72) Inventors: Yeon Seung SHIN, Daejeon (KR); Woo Goo PARK, Daejeon (KR); Nam Hoon PARK, Daejeon (KR)

(73) Assignee: Electronics and Telecommunications Research Institute, Daejeon (KR)

(21) Appl. No.: 14/227,555

(22) Filed: Mar. 27, 2014

(30) Foreign Application Priority Data
Mar. 27, 2013 (KR) 10-2013-0032596

(51) Int. Cl. H04B 7/02; H04W 72/04

(52) U.S. Cl. CPC H04B 7/026; H04W 72/04
USPC 455/450

(57) ABSTRACT

A method of selecting a plurality of cells and a method of distributed-transmitting data to enhance mobile data transmission rate in a wireless overlay network are disclosed. A cell selection method which selects a cell for distributed-transmission of data in a wireless overlay network of a plurality of cells may include receiving, by a base station, a request for distributed data transmission from a mobile terminal, and selecting a plurality of wireless communication devices for distributed-transmission of data to the mobile terminal among adjacent wireless communication devices to the mobile terminal based on received signal strength (RSS) information on the mobile terminal with respect to the adjacent wireless communication devices, available resource information on the adjacent wireless communication devices and a service profile of the mobile terminal.

### CROSS-REFERENCE TO RELATED APPLICATION

This application claims priority to and the benefit of Korean Patent Application No. 10-2013-0032596, filed on Mar. 27, 2013, in the Korean Intellectual Property Office, the disclosure of which is incorporated herein by reference.

### BACKGROUND

1. Field of the Invention

The present invention relates to a method of selecting a plurality of base stations (wireless communication devices) providing an optimal radio access environment to a multi-mode terminal moving in a wireless overlay communication environment of a plurality of wireless networks and a method of simultaneously distributed-transmitting data to the mobile terminal from the selected base stations to improve transmission rate of mobile data.

2. Description of the Related Art

As enhancement in performance of mobile terminals, such as smart phones and tablet PCs, and faster wireless transmission rate cause a surge in mobile traffic, techniques for processing high-capacity mobile traffic in a mobile communication system are required. Accordingly, mobile network operators install additional novel and high-performance mobile network systems to accommodate drastically increasing mobile traffic and build a large number of wireless local area networks (LANs) to offload the mobile traffic.

Although established to support peak data rate for offering stable services to users in any circumstance, mobile network systems do not operate at peak performance most of the time and thus 50% or more of available resources thereof are wasted. Thus, studies are carried out on methods of efficiently using wasted resources of mobile network systems to improve mobile data transmission capability.

Meanwhile, most mobile terminals, such as smart phones, support a dual mode of Long Term Evolution (LTE) and WiFi. Therefore, a mobile network system prepares resources for each mode. However, since a current mobile network system provides services through only one base station connected to a terminal, resources are inefficiently used and operators may need to additionally install base stations to prepare for a surge in mobile traffic.

### SUMMARY

An aspect of the present invention provides a method of selecting a plurality of cells and a method of distributed-transmitting data for improving transmission rate of mobile data in a wireless overlay network which enable efficient use of resources wasted in the wireless overlay network.

Another aspect of the present invention also provides a method of selecting a plurality of cells and a method of distributed-transmitting data for improving transmission rate of mobile data in a wireless overlay network which enable enhancement in transmission rate of mobile data.

Still another aspect of the present invention also provides a method of selecting a plurality of cells and a method distributed-transmitting data improving transmission rate of mobile data in a wireless overlay network which are capable of reducing energy used in a mobile communication system.

According to an aspect of the present invention, there is provided a cell selection method which selects a cell for distributed-transmission of data in a wireless overlay network of a plurality of cells, the method including receiving, by a base station, a request for distributed data transmission from a mobile terminal, and selecting a plurality of wireless communication devices for distributed-transmission of data to the mobile terminal among adjacent wireless communication devices to the mobile terminal based on received signal strength (RSS) information on the mobile terminal with respect to the adjacent wireless communication devices, available resource information on the adjacent wireless communication devices and a service profile of the mobile terminal.

The method may further include, before the receiving of the request, periodically collecting the available resource information on the adjacent wireless communication devices, and generating and managing an adjacent cell wireless environment information table of the mobile terminal by mapping the available resource information and the RSS information received from the mobile terminal.

The terminal may be a multi-mode mobile terminal to support at least two different communication technologies, and the selected wireless communication devices may use different communication technologies to provide services.

The selecting may include determining whether a corresponding wireless communication device exists among the adjacent wireless communication devices according to use priority order stored in a wireless communication device use priority table included in the service profile, and determining whether RSS of the mobile terminal with respect to the corresponding wireless communication device and available resources of the corresponding wireless communication device meet preset conditions when the corresponding wireless communication device exists.

The method may further include, after the determining, selecting a wireless communication device having minimum available resources and highest RSS when a plurality of corresponding wireless communication devices exists.

According to an aspect of the present invention, there is provided a distributed data transmission method which distributed-transmits data to a plurality of wireless communication devices in a wireless overlay network of a plurality of cells, the method including receiving, by a base station, RSS information on a mobile terminal with respect to adjacent wireless communication devices to the mobile terminal from the mobile terminal, selecting a plurality of wireless communication devices for distributed-transmission of data to the mobile terminal among the adjacent wireless communication devices based on the RSS information, available resource information on the adjacent wireless communication devices and a service profile of the mobile terminal, and distributed-transmitting the data to the selected wireless communication devices according to a distributed data transmission ratio between the wireless communication devices.

According to an aspect of the present invention, there is provided a base station including a reception unit to receive RSS information on a mobile terminal with respect to adjacent wireless communication devices to the mobile terminal from the mobile terminal, and a selection unit to select a plurality of wireless communication devices for distributed-transmission of data to the mobile terminal among the adjacent wireless communication devices based on the RSS information, available resource information on the adjacent wireless communication devices and a service profile of the mobile terminal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a heterogeneous wireless overlay network;

FIG. 2 illustrates a process of selecting a plurality of wireless communication devices providing an optimal service to a multi-mode mobile terminal and distributed-transmitting mobile data in the heterogeneous wireless overlay network according to an embodiment of the present invention;

FIG. 3 illustrates a state of a wireless resource of an adjacent base station managed by a resource management center according to an embodiment of the present invention;

FIG. 4 illustrates a wireless communication device use priority table included in a service profile signed by a user signs when subscribing to a mobile network service according to an embodiment of the present invention;

FIG. 5 is a flowchart illustrating a process that a cloud base station selects a cell for distributed data transmission according to an embodiment of the present invention;

FIG. 6 is a flowchart illustrating a process of selecting a wireless communication device for distributed data transmission in a service type of Type 1 according to an embodiment of the present invention;

FIG. 7 is a flowchart illustrating a process of selecting a wireless communication device for distributed data transmission in a service type of Type 2 according to an embodiment of the present invention;

FIG. 8 is a flowchart illustrating a process of selecting a wireless communication device for distributed data transmission in a service type of Type 3 according to an embodiment of the present invention;

FIG. 9 is a flowchart illustrating a process of determining a distributed data transmission ratio between a plurality of selected wireless communication devices according to an embodiment of the present invention; and

FIG. 10 illustrates a protocol for distributed-transmitting mobile traffic transmitted from a server by the cloud BS and for combining the mobile traffic by the mobile terminal according to an exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

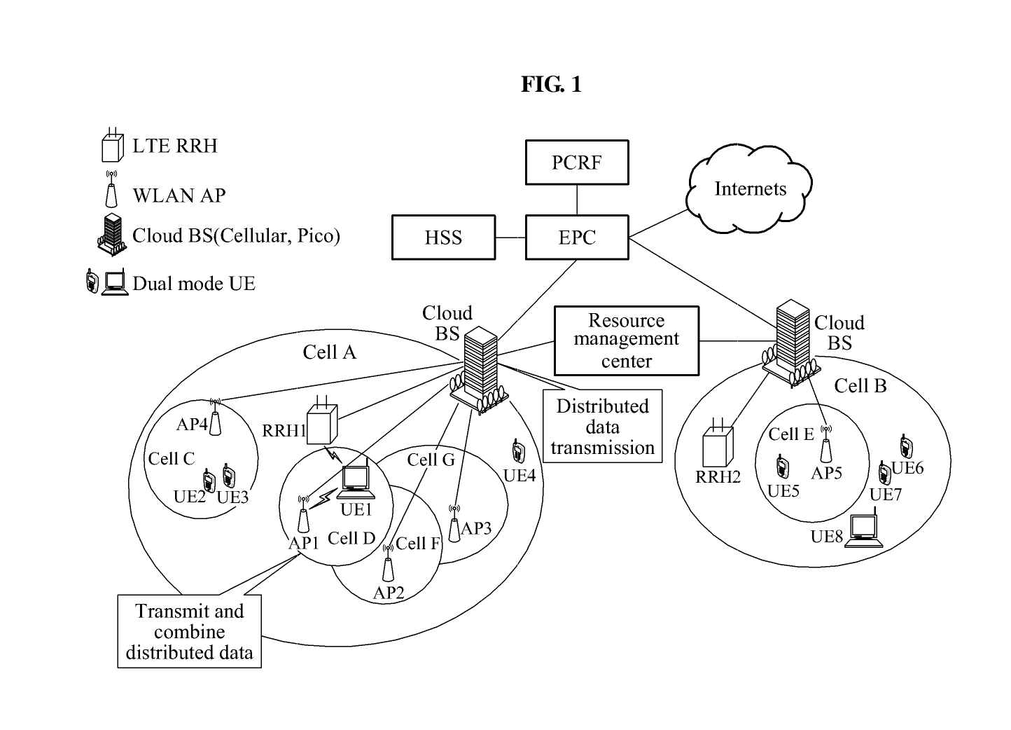

FIG. 1 illustrates a heterogeneous wireless overlay network.

In a mobile communication system, a base station may be divided into a radio unit (RU) (e.g., remote radio head (RRH)) functioning as an antenna and a digital unit (DU) to control a base band and the system, wherein the RU and DU may be connected through an optical cable. Here, a plurality of DU functions may be integrated into a single system to construct a cloud base station (BS).

The cloud BS may periodically collect BS resource information from adjacent cells and report the information to a resource management center, and the resource management center may store or manage resources of each BS based on locations.

As shown in FIG. 1, the heterogeneous wireless overlay network where a small cell is included in a macrocell area may be constructed by overlaying macrocells Cell A and Cell B serving wide areas and small cells Cell C, Cell D, Cell E, Cell F and Cell G serving local areas, for example, a picocell, a femtocell and a wireless local area network (WLAN). Cell A and Cell B may use Long Term Evolution (LTE) technology to serve the wide areas, while Cell C, Cell D, Cell E, Cell F and Cell G may provide services through WiFi technology. The small cell may include a low-power RRH, a picocell, a femtocell and a relay.

Referring to FIG. 1, a first mobile terminal UE 1, a second mobile terminal UE2, a third mobile terminal UE3 and a fourth mobile terminal UE4 located in a service area of Cell A may use LTE services through connection to RRH1 supporting an LTE antenna function, while a fifth mobile terminal UE5, a sixth mobile terminal UE6, a seventh mobile terminal UE7 and an eighth mobile terminal UE8 located in a service area of Cell B may use LTE services through connection to RRH2 supporting an LTE antenna function.

Meanwhile, the second mobile terminal UE2 and the third mobile terminal UE3 located in a service area of Cell C may be provided with WiFi and LTE services through connection to AP4 using WiFi technology and connection to RRH1 using LTE technology, while the first mobile terminal UE 1 located in a service area of Cell D may be provided with WiFi services through connection to AP1, AP2 and AP3 and provided with LTE services through connection to RRH1.

In the heterogeneous wireless overlay network, when a request for distributed transmission of mobile data from a dual-mode mobile terminal is received, the cloud BS may analyze received signal strength (RSS) information on wireless communication devices adjacent to the mobile terminal, for example, WLAN APs and LTE RRHs, available resource information on each adjacent wireless communication device and a service profile signed by a user of the mobile terminal, which are transmitted from the mobile terminal, and select wireless communication devices providing an optimal service to the mobile terminal. Here, the cloud BS may calculate currently possible transmission rates of the selected wireless communication devices and determine a distributed data transmission ratio between the selected wireless communication devices based on the calculated transmission rates.

Then, the cloud BS may allocate a sequence number to the mobile data and distributed-transmit the mobile data based on the calculated distributed transmission ratio in accordance with a protocol of a radio access technology, such as LTE and WiFi, supported by the selected wireless communication devices, and the mobile terminal may combine the distributed-transmitted data and transmit the combined data to an upper layer.

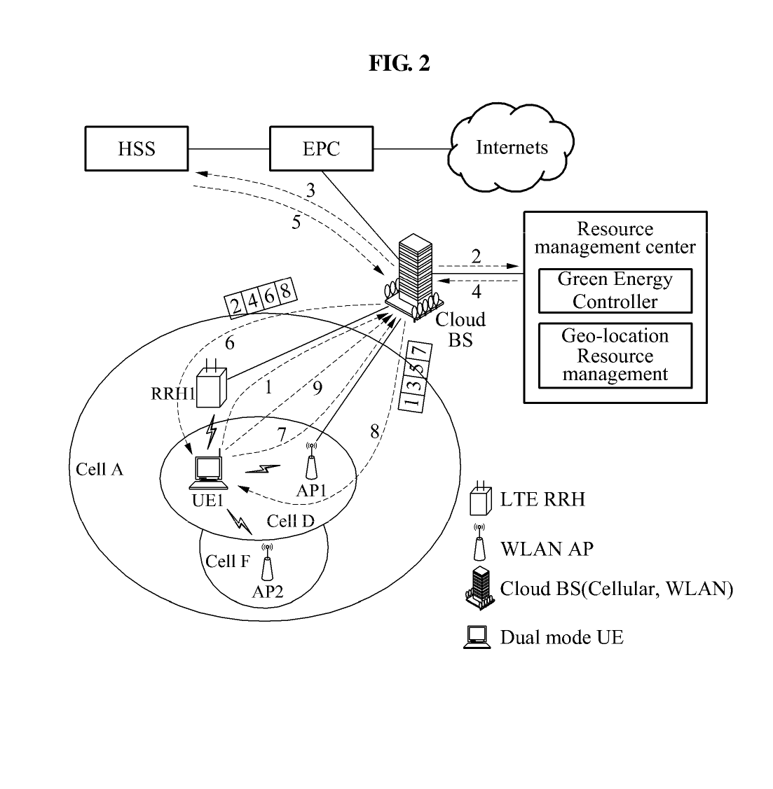

FIG. 2 illustrates a process of selecting a plurality of wireless communication devices providing an optimal service to a multi-mode mobile terminal and distributed-transmitting mobile data in the heterogeneous wireless overlay network according to an embodiment of the present invention.

As shown in FIG. 2, when the mobile terminal UE1 supporting a dual mode, for example, LTE and WiFi, requests distributed-transmission of mobile data while providing an Internet service in connection with RRH1, the cloud BS and an Evolved Packet Core (EPC) in operation 1, the cloud BS requests, from the resource management center, resource states of wireless transmission technologies for base stations or cells adjacent to the first mobile terminal based on wireless environment information on the base stations received from the first mobile terminal in operation 2 and requests service profile information on the mobile terminal from a home subscriber server (HSS) in operation 3.

When the cloud BS is notified of the resource information on the wireless transmission technologies for the adjacent base stations from the resource management center in operation 4 and notified of the service profile information from the HSS in operation 5, the cloud BS selects a plurality of wireless communication devices providing an optimal service to the first mobile terminal, for example, RRH1 and AP1, among the adjacent wireless communication devices by using RSS information on the adjacent wireless communication devices, available resource information on each adjacent wireless communication device and a service profile of the first mobile terminal, which are received from the first mobile terminal, and notifies the first mobile terminal of a selection result in operation 6.

Then, the first mobile terminal requests setup of a new session using information on a plurality of wireless transmission technologies received from the cloud BS in operation 7, is notified that the new session is completely set up in operation 8, and then notifies the cloud BS that the terminal is ready for reception in operation 9. Subsequently, the cloud BS may distributed-transmit the mobile data to be transmitted to the first mobile terminal 1 to RRH1 using LTE technology and AP1 using WiFi technology. For example, FIG. 2 shows that the cloud BS transmits “2, 4, 6 and 8” of data of “1, 2, 3, 4, 5, 6, 7 and 8” via LTE and simultaneously transmits “1, 3, 5 and 7” through a WLAN. Whether to distributed-transmit mobile data may be automatically determined in the network based on variable mobile traffic.

Meanwhile, as shown in FIG. 2, the resource management center constructs an individual mobile user-oriented radio access environment and provides an optimal candidate base station list for handover through location-based resource management. Also, the resource management center may conduct power on and off through environment recognition of adjacent base stations by a green ENERGY controller, thereby saving energy used in a mobile communication system.

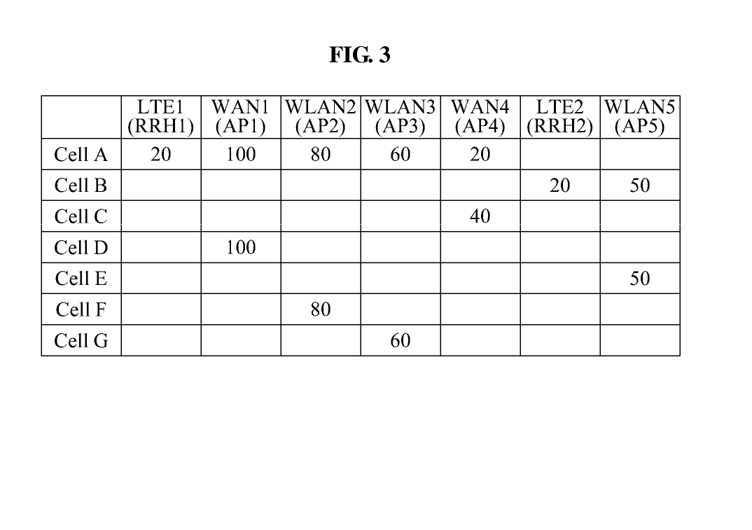

FIG. 3 illustrates a state of a wireless resource of an adjacent base station managed by the resource management center according to an embodiment of the present invention.

The cloud BS may periodically collect available resource information on wireless transmission technology from adjacent base stations, and the resource management center may conduct location-based management of the available resource information on the wireless transmission technology collected by the cloud BS.

FIG. 3 shows that Cell A is overlaid with four small cells Cell B, Cell C, Cell D and Cell G, and Cell B is overlaid with a small cell Cell E. Referring to FIG. 3, in a service area of Cell A, LTE1 technology has 20 available resources, WLAN1 technology has 100 available resources, WLAN2 technology has 80 available resources, WAN3 technology has 60 available resources and WAN4 technology has 20 available resources. In a service area of Cell B, LTE2 technology has 20 available resources and WLAN5 technology has 50 available resources. The resource management center may be disposed physically in the cloud BS and manage information on available resources of each cell in a table.

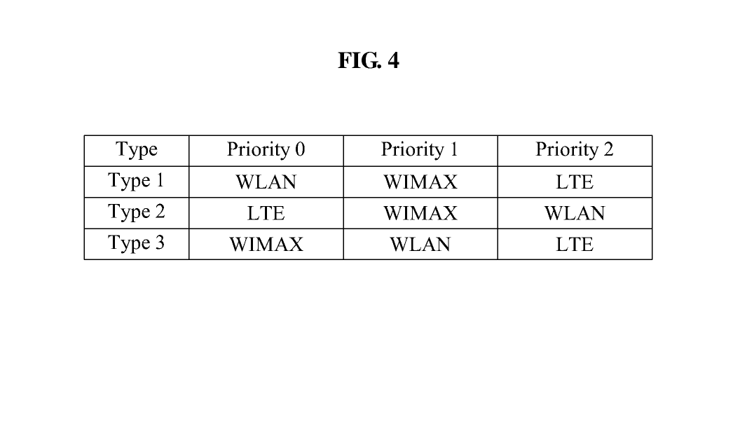

FIG. 4 illustrates a wireless communication device use priority table included in a service profile signed by a user when subscribing to a mobile communication service according to an embodiment of the present invention.

In “Type 1,” WLAN, LTE and Worldwide Interoperability for Microwave Access (WIMAX) technologies are employed in priority order of WLAN>WIMAX>LTE so as to save fees. In “Type 2,” the technologies are employed in priority order of LTE>WIMAX>WLAN for high-quality mobile services on movement. In “Type 3,” the technologies are employed in priority order of WIMAX>WLAN>LTE for indoor uses of high-speed data services. Operators may change the wireless communication device use priority table via access to the HSS.

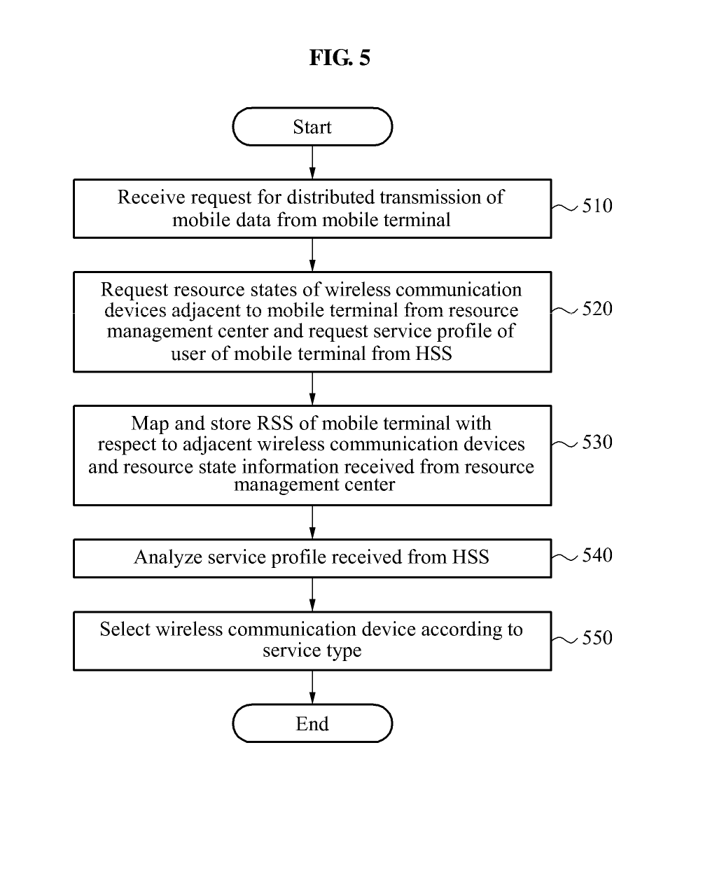

FIG. 5 is a flowchart illustrating a process that the cloud BS selects a cell for distributed data transmission according to an embodiment of the present invention.

The following example illustrates that a mobile terminal supporting a dual mode, such as LTE and WLAN, transmits a request for distributed data transmission including RSSs of wireless communication devices adjacent to the mobile terminal, for example, RRH1, AP1 and AP2, to the cloud BS so as to download a large video while providing an Internet service using LTE technology.

When the request for distributed data transmission is received from the mobile terminal in operation 510, the cloud BS requests resource states of the adjacent wireless communication devices from the resource management center based on RSS information on the adjacent wireless communication devices received from the mobile terminal and simultaneously requests a service profile of a user of the mobile terminal from the HSS in operation 520.

Next, the cloud BS may generate and store an adjacent cell wireless environment information table of the mobile terminal by mapping the resource information on the wireless communication devices received from the resource management center and the RSS information on the wireless communication devices received from the mobile terminal in operation 530. The cloud BS analyses the service profile received from the HSS in operation 540 and selects a plurality of wireless communication devices used for distributed transmission of data to the mobile terminal based on a service type requested by the user of the mobile terminal in operation 550. Here, the selected wireless communication devices may use different communication techniques to provide services.

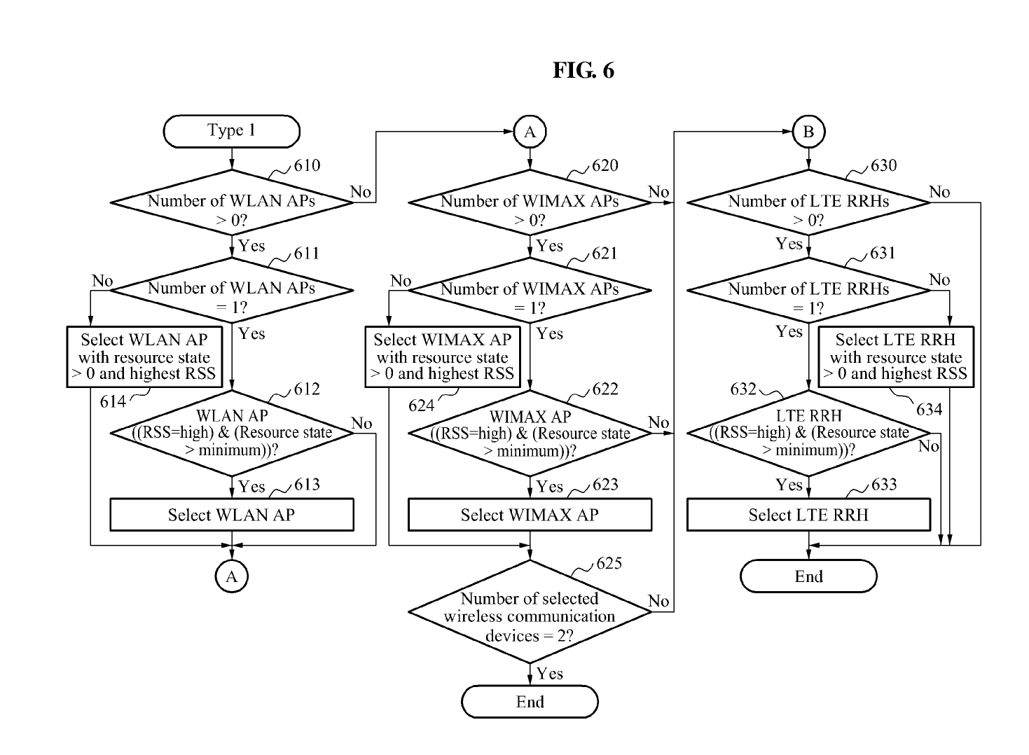

FIG. 6 is a flowchart illustrating a process of selecting a wireless communication device for distributed data transmission in a service type of Type 1 according to an embodiment of the present invention.

When the service type recorded in the wireless communication device use priority table of FIG. 4 is “Type 1,” the cloud BS retrieves information a WLAN AP from an adjacent cell wireless environment information table first.

For example, when there is one WLAN AP in the adjacent cell wireless environment information table, the cloud BS analyzes adequacy of RSS and a resource state of the WLAN AP. When the RSS and the resource state meet predetermined conditions, the cloud BS selects the WLAN AP as a wireless communication device for distributed data transmission in operations 610, 611, 612 and 613. However, when two or more WLAN APs are present in the adjacent cell wireless environment information table, the cloud BS selects a WLAN AP having a minimum amount of available resources and highest RSS as a wireless communication device for distributed transmission in operations 610, 611 and 614. Here, the minimum amount of available resources may be 30% or greater of total resources of the WLAN AP.

Meanwhile, when no WLAN AP is present in the adjacent cell wireless environment information table or an appropriate WLAN AP is not selected, the cloud BS conducts additional selection of a wireless communication device for distributed transmission, for example, WIMAX.

When there is one WIMAX AP in the adjacent cell wireless environment information table, the cloud BS analyzes adequacy of RSS and a resource state of the WIMAX AP. When the RSS and the resource state meet predetermined conditions, the cloud BS selects the WIMAX AP as a wireless communication device for distributed data transmission in operations 620, 621, 622 and 623. However, when two or more WIMAX APs are present in the adjacent cell wireless environment information table, the cloud BS selects a WIMAX AP having a minimum amount of available resources, which is 30% or greater of total resources of the WIMAX AP, and highest RSS as a wireless communication device for distributed transmission in operations 620, 621 and 624.

When no WIMAX AP is present in the adjacent cell wireless environment information table, an appropriate WIMAX AP is not selected, or two wireless communication devices are not selected yet, the cloud BS conducts additional selection of a wireless communication device for distributed transmission, for example, LTE RRH. However, when two wireless communication devices are selected, the process of selecting the wireless communication device for distributed data transmission may terminate in operation 625.

When two wireless communication devices are not selected, the cloud BS investigates an LTE RRH list from the adjacent cell wireless environment information table. When there is one LTE RRH and RSS and a resource state of the LTE RRH meet predetermined conditions, for example, that the LTE RRH has a minimum amount of available resources which is 30% or greater of total resources of the LTE RRH, the cloud BS selects the LTE RRH as a wireless communication device for distributed data transmission and terminates the process of selecting the wireless communication device in operations 630, 631, 632 and 633.

However, when two or more LTE RRHs are present in the adjacent cell wireless environment information table, the cloud BS selects an LTE RRH having a minimum amount of resources and highest RSS as a wireless communication device for distributed transmission and terminates the process of selecting the wireless communication device in operations 630, 631 and 634.

When no LTE RRH is present in the adjacent cell wireless environment information table or an appropriate LTE RRH is not found, the cloud BS may terminate the process of selecting the wireless communication device.

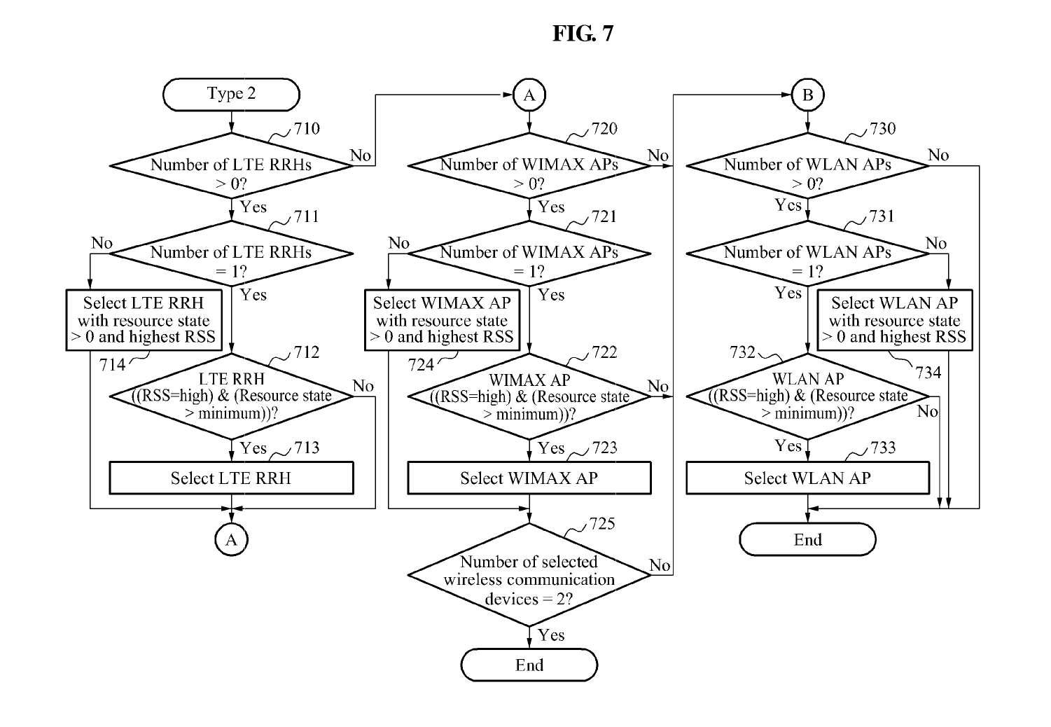

FIG. 7 is a flowchart illustrating a process of selecting a wireless communication device for distributed data transmission in a service type of Type 2 according to an embodiment of the present invention.

When the service type is “Type 2,” the cloud BS may select a wireless communication device through a similar process to used in “Type 1.” Here, wireless communication devices may be selected according to the priority order of FIG. 4.

For instance, when there is one LTE RRH in the adjacent cell wireless environment information table, the cloud BS analyzes adequacy of RSS and a resource state of the LTE RRH. When the RSS and the resource state meet predetermined conditions, the cloud BS selects the LTE RRH as a wireless communication device for distributed data transmission in operations 710, 711, 712 and 713. However, when two or more LTE RRHs are present in the adjacent cell wireless environment information table, the cloud BS selects an LTE RRH having a minimum amount of resources and highest RSS as a wireless communication device for distributed transmission in operations 710, 711 and 714. Here, the minimum amount of resources may be 30% or greater of total resources of the LTE RRH.

When no LTE RRH is present in the adjacent cell wireless environment information table or an appropriate LTE RRH is not selected, the cloud BS conducts additional selection of a wireless communication device for distributed transmission, for example, WIMAX.

When there is one WIMAX AP in the adjacent cell wireless environment information table, the cloud BS analyzes adequacy of RSS and a resource state of the WIMAX AP. When the RSS and the resource state meet predetermined conditions, the cloud BS selects the WIMAX AP as a wireless communication device for distributed data transmission in operations 720, 721, 722 and 723. However, when two or more WIMAX APs are present in the adjacent cell wireless environment information table, the cloud BS selects a WIMAX AP having a minimum amount of resources and highest RSS as a wireless communication device for distributed transmission in operations 720, 721 and 724.

When no WIMAX AP is present in the adjacent cell wireless environment information table, an appropriate WIMAX AP is not selected, or two wireless communication devices are not selected yet, the cloud BS conducts additional selection of a wireless communication device for distributed transmission, for example, WLAN. However, when two wireless communication devices, the LTE RRH and WIMAN AP, are selected, the process of selecting the wireless communication device for distributed data transmission may terminate in operation 725.

When two wireless communication devices are not selected, the cloud BS investigates a WLAN AP list from the adjacent cell wireless environment information table. When there is one WLAN AP and RSS and a resource state of the WLAN AP meet predetermined conditions, the cloud BS selects the WLAN AP as a wireless communication device for distributed data transmission and terminates the process of selecting the wireless communication device in operations 730, 731, 732 and 733.

However, when two or more WLAN APs are present in the adjacent cell wireless environment information table, the cloud BS selects a WLAN AP having a minimum amount of resources and highest RSS as a wireless communication device for distributed transmission and terminates the process of selecting the wireless communication device in operations 730, 731 and 734.

When no WLAN AP is present in the adjacent cell wireless environment information table or an appropriate WLAN AP is not found, the cloud BS may terminate the process of selecting the wireless communication device.

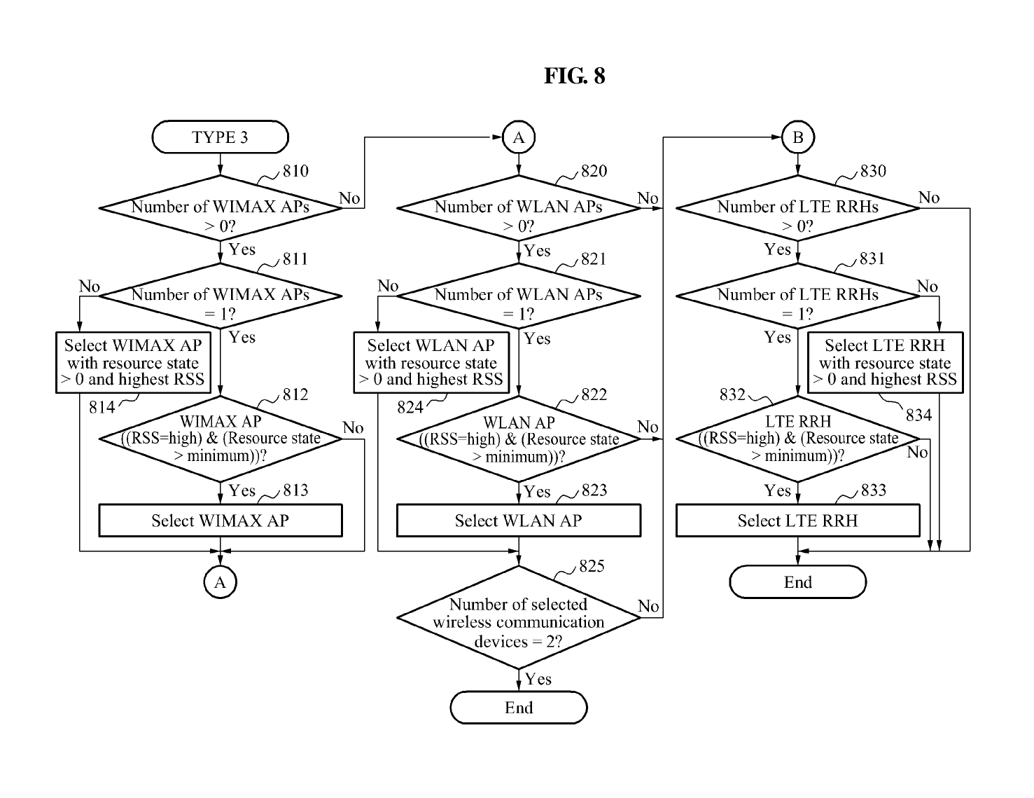

FIG. 8 is a flowchart illustrating a process of selecting a wireless communication device for distributed data transmission in a service type of Type 3 according to an embodiment of the present invention.

When the service type is “Type 3,” the cloud BS may select a wireless communication device through a similar process to used in “Type 1” or “Type 2” according to the priority order of “Type 3” illustrated in FIG. 4.

For instance, when there is one WIMAX AP in the adjacent cell wireless environment information table, the cloud BS analyzes adequacy of RSS and a resource state of the WIMAX AP. When the RSS and the resource state meet predetermined conditions, the cloud BS selects the WIMAX AP as a wireless communication device for distributed data transmission in operations 810, 811, 812 and 813. However, when two or more WIMAX APs are present in the adjacent cell wireless environment information table, the cloud BS selects a WIMAX AP having a minimum amount of resources and highest RSS as a wireless communication device for distributed transmission in operations 810, 811 and 814. Likewise, the minimum amount of resources may be 30% or greater of total resources of the WIMAX AP.

When no WIMAX AP is present in the adjacent cell wireless environment information table or an appropriate WIMAX AP is not selected, the cloud BS conducts additional selection of a wireless communication device for distributed transmission, for example, WLAN.

When there is one WLAN AP in the adjacent cell wireless environment information table, the cloud BS analyzes adequacy of RSS and a resource state of the WLAN AP. When the RSS and the resource state meet predetermined conditions, the cloud BS selects the WLAN AP as a wireless communication device for distributed data transmission in operations 820, 821, 822 and 823. However, when two or more WLAN APs are present in the adjacent cell wireless environment information table, the cloud BS selects a WLAN AP having a minimum amount of resources and highest RSS as a wireless communication device for distributed transmission in operations 820, 821 and 824.

When no WLAN AP is present in the adjacent cell wireless environment information table, an appropriate WLAN AP is not selected, or two wireless communication devices are not selected yet, the cloud BS conducts additional selection of a wireless communication device for distributed transmission, for example, LTE RRH. However, when two wireless communication devices are selected, the process of selecting the wireless communication device for distributed data transmission may terminate in operation 825.

When two wireless communication devices are not selected, the cloud BS investigates an LTE RRH list from the adjacent cell wireless environment information table. When there is one LTE RRH and RSS and a resource state of the LTE RRH meet predetermined conditions, the cloud BS selects the LTE RRH as a wireless communication device for distributed data transmission and terminates the process of selecting the wireless communication device in operations 830, 831, 832 and 833. However, when two or more LTE RRHs are present in the adjacent cell wireless environment information table, the cloud BS selects an LTE RRH having a minimum amount of resources and highest RSS as a wireless communication device for distributed transmission and terminates the process of selecting the wireless communication device in operations 830, 831 and 834.

When no LTE RRH is present in the adjacent cell wireless environment information table or an appropriate LTE RRH is not found, the cloud BS may terminate the process of selecting the wireless communication device.

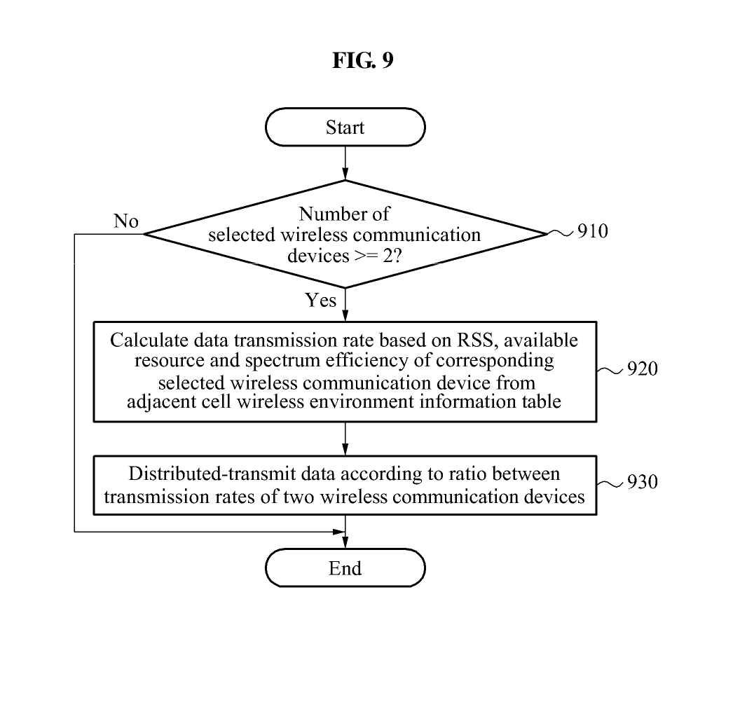

FIG. 9 is a flowchart illustrating a process of determining a distributed data transmission ratio between a plurality of selected wireless communication devices according to an embodiment of the present invention.

When a single wireless communication device is selected, the cloud BS transmits all packets to the selected wireless communication device. However, when two or more wireless communication devices are selected in operation 910, the cloud BS calculates possible data transmission rate of each wireless communication device based on channel state information, for example, a Channel Quality Indicator (CQI) measurement of LTE and a WiFi RSS measurement of WiFi, on each selected wireless communication device, available resource information on each selected wireless communication device from the adjacent cell wireless environment information table and spectrum efficiency of each selected wireless communication devices in operation 920, determines the distributed data transmission ratio based on a ratio between the transmission rates of the wireless communication devices and distributed-transmits data according to the distributed data transmission ratio in operation 930.

The cloud BS may include a reception unit to receive RSS information on a mobile terminal with respect to wireless communication devices adjacent to the mobile terminal from the mobile terminal and a selection unit to select a plurality of wireless communication devices to distributed-transmit data to the mobile terminal among the adjacent wireless communication devices based on the RSS information, available resource information on the adjacent wireless communication devices and a service profile of the mobile terminal.

Further, the cloud BS may further include a collection unit to periodically collect the available resource information on the adjacent wireless communication devices in a wireless overlay network of a plurality of cells and a management unit to generate and manage an adjacent cell wireless environment information table of the mobile terminal by mapping the available resource information and the RSS information received from the mobile terminal. Here, the mobile terminal may a multi-mode mobile terminal supporting at least two different communication technologies, and the selected wireless communication devices may use different communication technologies to provide services.

The selection unit may determine existence of a corresponding wireless communication device among the adjacent wireless communication devices according to use priority order stored in a wireless communication device use priority table included in the service profile, and determine whether RSS of the mobile terminal with respect to the corresponding wireless communication device and available resources of the corresponding wireless communication device meet preset conditions when the corresponding wireless communication device exists. However, when a plurality of corresponding wireless communication devices exists, the selection unit may select a wireless communication device having minimum available resources and highest RSS.

The cloud BS may further include a transmission unit to distributed-transmit the data to the selected wireless communication devices according to a distributed data transmission ratio between the wireless communication devices. The transmission unit may calculate currently possible transmission rates of the respective selected wireless communication devices and determine a distributed data transmission ratio between the selected wireless communication devices based on the calculated transmission rates. Further, the transmission unit may calculate possible data transmission rate of each wireless communication device based on channel state information on each selected wireless communication device, available resource information on each selected wireless communication device and spectrum efficiency of each selected wireless communication devices. Also, the transmission unit may allocate a sequence number to data to be transmitted to the mobile terminal and distributed-transmit the data based on the distributed data transmission ratio between the wireless communication devices in accordance with a protocol supported by the selected wireless communication devices. Here, the distributed-transmitted data is stored in a reception buffer of the mobile terminal, subjected to a redundancy test, and transmitted to an application program of the mobile terminal according to the sequence number.

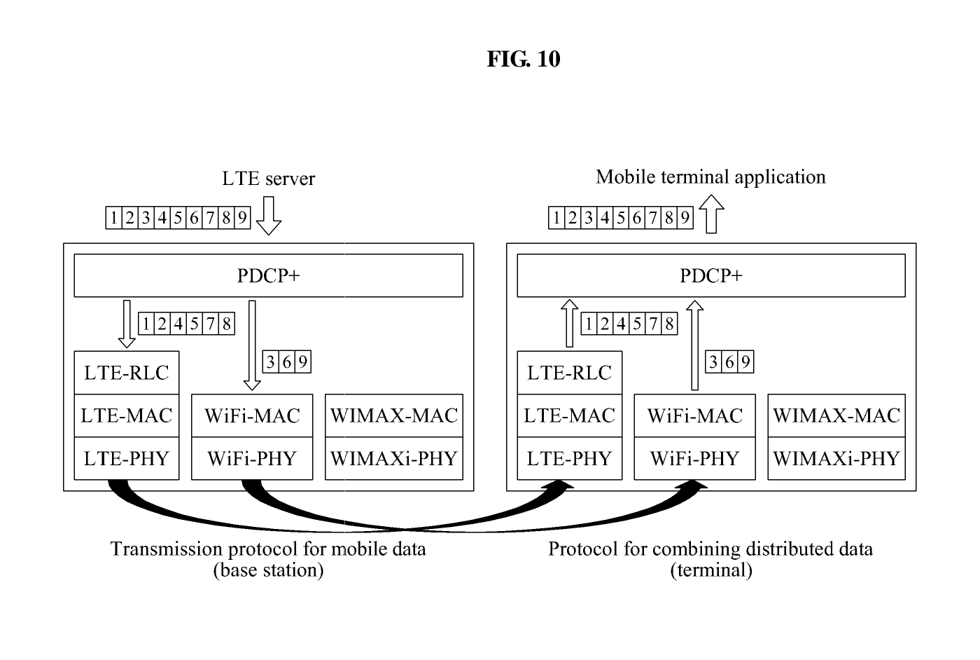

FIG. 10 illustrates a protocol for distributed-transmitting mobile traffic transmitted from a server by the cloud BS and for combining the mobile traffic by the mobile terminal according to an exemplary embodiment of the present invention.

The following example illustrates that a first wireless communication device using LTE technology and a second wireless communication device using WiFi technology are selected and a transmission rate ratio between the first wireless communication device and the second wireless communication device is 3:1.

Process of Distributed-Transmitting Mobile Data

When the cloud BS receives mobile data of 1, 2, 3, 4, 5, 6, 7, 8 and 9 transmitted from an LTE server through a PDCP+ layer, the PDCP+ layer allocates a sequence number to a PDP packet, conducts header compression, ciphering and PDCP header addition, and distributed-transmits the data to an LTE-Radio Link Control (RLC) layer and a WiFi-Media Access Control (MAC) layer according to a distribution ratio between the wireless communication devices determined on the process of FIG. 9. For instance, FIG. 10 illustrates that data of “1, 2, 4, 5, 7 and 8” is transmitted to the LTE-RLC layer and data of “3, 6 and 9” is transmitted to the WiFi MAC layer. Here, the packet received by LTE-RLC may be transmitted to the mobile terminal through LTE-MAC and LTE-PHY, while the packet received by WiFi-MAC may be transmitted to the mobile terminal through WiFi-PHY.

Process of Combining Distributed-Transmitted Data

The mobile terminal transmits the data of “1, 2, 4, 5, 7 and 8,” received by the LTE-RLC layer via the LTE-PHY and LTE-MAC layers in accordance with an LTE protocol, to the PDCP+ layer. The PDCP+ layer conducts PDCP header separation, deciphering and header decompression on the received packet and stores the packet in the reception buffer. Meanwhile, the PDCP+ layer conducts header separation, deciphering and header decompression on the data of “3, 6 and 9,” received through the WiFi-PHY and WiFi-MAC layers in accordance with a WiFi protocol, and stores the data in the reception buffer. Subsequently, the PDCP+ layer examines redundancy of the data stored in the reception buffer and transmits the data to an upper layer according to PCDP sequence number order. Here, the upper layer transmits the data to an application program of the mobile terminal.

As described above, according to exemplary embodiments, a plurality of wireless communication devices for distributed-transmission of data to a mobile terminal among wireless communication devices adjacent to the mobile terminal based on RSS information on the mobile terminal with respect to the adjacent wireless communication devices, available resource information on the adjacent wireless communication devices and a service profile of the mobile terminal, which are transmitted from the mobile terminal, thereby enabling efficient use of resources wasted in a wireless overlay network.

Further, data is distributed-transmitted based on a distributed data transmission ratio between the plurality of wireless communication devices, thereby enhancing transmission rate of mobile data.

A mobile communication system may use reduced energy by constructing an individual mobile user-oriented radio access environment, providing an optimal candidate base station list and expanding a service area for handover, and conducting power on and off through environment recognition of adjacent base stations.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A cell selection method which selects a cell for distributed-transmission of data in a wireless overlay network of a plurality of cells, the method comprising:
receiving, by a base station, a request for distributed data transmission from a mobile terminal; and
selecting a plurality of wireless communication devices for distributed-transmission of data to the mobile terminal among adjacent wireless communication devices to the mobile terminal based on received signal strength (RSS) information on the mobile terminal with respect to the adjacent wireless communication devices, available resource information on the adjacent wireless communication devices and a service profile of the mobile terminal.

2. The method of claim 1, further comprising, before the receiving of the request, periodically collecting the available resource information on the adjacent wireless communication devices; and generating and managing an adjacent cell wireless environment information table of the mobile terminal by mapping the available resource information and the RSS information received from the mobile terminal.

3. The method of claim 1, wherein the terminal is a multi-mode mobile terminal to support at least two different communication technologies, and the selected wireless communication devices use different communication technologies to provide services.

4. The method of claim 1, wherein the selecting comprises determining whether a corresponding wireless communication device exists among the adjacent wireless communication devices according to use priority order stored in a wireless communication device use priority table comprised in the service profile; and determining whether RSS of the mobile terminal with respect to the corresponding wireless communication device and available resources of the corresponding wireless communication device meet preset conditions when the corresponding wireless communication device exists.

5. The method of claim 4, further comprising, after the determining, selecting a wireless communication device having minimum available resources and highest RSS when a plurality of corresponding wireless communication devices exists.

6. A distributed data transmission method which distributed-transmits data to a plurality of wireless communication devices in a wireless overlay network of a plurality of cells, the method comprising:
receiving, by a base station, received signal strength (RSS) information on a mobile terminal with respect to adjacent wireless communication devices to the mobile terminal from the mobile terminal;
selecting a plurality of wireless communication devices for distributed-transmission of data to the mobile terminal among the adjacent wireless communication devices based on the RSS information, available resource information on the adjacent wireless communication devices and a service profile of the mobile terminal; and
distributed-transmitting the data to the selected wireless communication devices according to a distributed data transmission ratio between the wireless communication devices.

7. The method of claim 6, wherein the distributed-transmitting comprises calculating currently possible transmission rates of the respective selected wireless communication devices; and determining the distributed data transmission ratio between the wireless communication devices based on the calculated transmission rates.

8. The method of claim 7, wherein the calculating calculates possible data transmission rate of each wireless communication device based on channel state information on each of the selected wireless communication devices, the available resource information on each wireless communication device and spectrum efficiency of each wireless communication device.

9. The method of claim 7, further comprising allocating a sequence number to the data to be transmitted to the mobile terminal before the distributed-transmitting, wherein the distributed-transmitting distributed-transmits the data allocated the sequence number based on the distributed data transmission ratio between the wireless communication devices in accordance with a protocol supported by the selected wireless communication devices.

10. The method of claim 7, wherein the distributed-transmitted data is stored in a reception buffer of the mobile terminal, subjected to a redundancy test, and transmitted to an application program of the mobile terminal according to the sequence number.

11. A base station comprising:
a reception unit to receive received signal strength (RSS) information on a mobile terminal with respect to adjacent wireless communication devices to the mobile terminal from the mobile terminal; and
a selection unit to select a plurality of wireless communication devices for distributed-transmission of data to the mobile terminal among the adjacent wireless communication devices based on the RSS information, available resource information on the adjacent wireless communication devices and a service profile of the mobile terminal.

12. The base station of claim 11, further comprising a collection unit to periodically collect the available resource information on the adjacent wireless communication devices in a wireless overlay network of a plurality of cells; and a management unit to generate and manage an adjacent cell wireless environment information table of the mobile terminal by mapping the available resource information and the RSS information received from the mobile terminal.

13. The base station of claim 11, wherein the terminal is a multi-mode mobile terminal to support at least two different communication technologies, and the selected wireless communication devices use different communication technologies to provide services.

14. The base station of claim 11, wherein the selection unit determines whether a corresponding wireless communication device exists among the adjacent wireless communication devices according to use priority order stored in a wireless communication device use priority table comprised in the service profile, and determines whether RSS of the mobile terminal with respect to the corresponding wireless communication device and available resources of the corresponding wireless communication device meet preset conditions when the corresponding wireless communication device exists.

15. The base station of claim 14, wherein the selection unit selects a wireless communication device having minimum available resources and highest RSS when a plurality of corresponding wireless communication devices exists.

16. The base station of claim 11, further comprising a transmission unit to distributed-transmit the data to the selected wireless communication devices according to a distributed data transmission ratio between the wireless communication devices.

17. The base station of claim 16, wherein the transmission unit calculates currently possible transmission rates of the respective selected wireless communication devices, and determines the distributed data transmission ratio between the wireless communication devices based on the calculated transmission rates.

18. The base station of claim 17, wherein the transmission unit calculates possible data transmission rate of each wireless communication device based on channel state information on each of the selected wireless communication devices, the available resource information on each wireless communication device and spectrum efficiency of each wireless communication device.

19. The base station of claim 17, wherein the transmission unit allocates a sequence number to the data to be transmitted to the mobile terminal and distributed-transmits the data allocated the sequence number based on the distributed data transmission ratio between the wireless communication devices in accordance with a protocol supported by the selected wireless communication devices.

20. The base station of claim 17, wherein the distributed-transmitted data is stored in a reception buffer of the mobile terminal, subjected to a redundancy test, and transmitted to an application program of the mobile terminal according to the sequence number.
